(19) United States
(12) Patent Application Publication
(10) Pub. No.: US 2026/0275924 A1
(43) Pub. Date: Sep. 17, 2026

(54) CONTROL SYSTEM FOR MULTI-FUEL GENERATOR SET AND CONTROL METHOD THEREOF, AND GENERATOR SET

(71) Applicant: CHONGQING RATO TECHNOLOGY CO., LTD, CHONGQING (CN)

(72) Inventors: Zhengyong YU, CHONGQING (CN); Meng LUO, CHONGQING (CN); Changchun YAO, CHONGQING (CN)

(73) Assignee: CHONGQING RATO TECHNOLOGY CO., LTD, CHONGQING (CN)

(21) Appl. No.: 19/358,566

(22) Filed: Oct. 15, 2025

(30) Foreign Application Priority Data
Mar. 11, 2025 (CN) 2025102806877

(51) Int. Cl. F02D 29/06; F02B 63/04; F02D 19/06; F02D 41/20; F02P 5/15

(52) U.S. Cl. CPC F02D 29/06; F02B 63/042; F02D 19/061; F02D 19/0676; F02D 41/20; F02P 5/1502; F02D 2200/023; F02D 2200/0611; F02D 2200/101

(57) ABSTRACT

The present disclosure discloses a control system for a multi-fuel generator set and a control method thereof, and a generator set. The control system includes a fuel switching switch, an engine start switch, a carburetor, a gas supply electric control valve, a signal detection module, an ignition device and a control device; the fuel switching switch and the engine start switch are respectively connected to the signal detection module, and the carburetor, the gas supply electric control valve, the signal detection module, and the ignition device are respectively connected to the control device; the signal detection module is configured to detect a working state signal of the multi-fuel engine and send the detected working state signal to the control device.

### CROSS-REFERENCE TO RELATED APPLICATIONS

The application claims priority to Chinese patent application No. 2025102806877, filed on Mar. 11, 2025, the entire contents of which are incorporated herein by reference.

### TECHNICAL FIELD

The present disclosure relates to the technical field of generator sets, and in particular to a control system for a multi-fuel generator set and a control method thereof, and a generator set.

### BACKGROUND

A multi-fuel generator set includes a multi-fuel engine and a generator, and is a power generation device that uses the multi-fuel engine to drive the generator to achieve power output. At present, there are two main types of multi-fuel generator sets according to fuel types. One type is a pure gas multi-fuel generator set, which uses at least two of gas fuels such as LPG (liquefied petroleum gas), NG (natural gas), hydrogen, coal gas, and biogas as engine fuel. The other type is a gas-liquid mixed multi-fuel generator set, which uses one or more gas fuels (such as LPG, NG, etc.) and one liquid fuel (such as gasoline, etc.) as engine fuel.

The multi-fuel generator set is usually equipped with a fuel switching switch. Before the engine is started, the fuel switching switch is usually configured to switch a type of fuel to be supplied to a carburetor of the engine. Only one type of fuel is selected when the engine is running. The existing multi-fuel generator has a diaphragm pressure reducing valve installed between a gas fuel supply pipeline and a gas fuel inlet of the carburetor. When the selected fuel is gas fuel, a negative pressure is generated in an engine cylinder during an engine intake stroke. The carburetor relies on the negative pressure to open the diaphragm pressure reducing valve, so that the gas fuel in the gas fuel supply pipeline enters the carburetor through the diaphragm pressure reducing valve, realizing gas fuel supply during engine startup and operation.

This method of passively opening the diaphragm pressure reducing valve through the negative pressure to allow the gas fuel to enter the engine requires extremely high precision in fitting of mechanical parts such as the engine and the diaphragm pressure reducing valve. Minor differences between the parts (such as differences in sealing of the engine cylinder, differences in spring elasticity of the diaphragm pressure reducing valve, etc.) may lead to inconsistent gas fuel intakes at a same rotation speed, thereby affecting consistency and stability of a gas intake of the carburetor to the engine cylinder. It is difficult to ensure stable combustion effects and power generation efficiency, resulting in poor working stability of the multi-fuel generator set.

When using the gas fuel to start the engine, this method of passively opening the diaphragm pressure reducing valve through the negative pressure to allow the gas fuel to enter the engine requires passive air supply, that is, when starting the engine, a starter motor rotates, and at the same time, by controlling a switch of an air valve (i.e., a throttle), a negative pressure is generated in the carburetor, thereby opening the diaphragm pressure reducing valve, and a gas fuel supply device then delivers the gas fuel to the carburetor through the diaphragm pressure reducing valve. However, a degree of opening of the diaphragm pressure reducing valve is related to the negative pressure of the carburetor. Only when the engine reaches a certain rotation speed can the carburetor generate the negative pressure to open the diaphragm pressure reducing valve, thereby allowing the gas fuel supply device to deliver gas fuel to the carburetor through the diaphragm pressure reducing valve. Due to limitation of starting time of the starter motor, opening time of the diaphragm pressure reducing valve is short and the opening degree is small each time the starter motor works. This results in less gas fuel entering the carburetor each time during starting. Therefore, this passive air supply method usually requires opening and closing the air valve and intermittently starting the starter motor 3 to 6 times before the generator set can be started successfully. Therefore, there are problems such as difficult starting and cumbersome operations.

Therefore, how to improve engine starting performance of the multi-fuel generator set when gas fuel is used and working stability of the multi-fuel generator set is an issue that needs to be solved urgently.

### SUMMARY

The present disclosure aims to solve at least one of the technical problems existing in the prior art, and in particular innovatively proposes a control system for a multi-fuel generator set and a control method thereof, and a generator set to improve engine starting performance of the multi-fuel generator set when gas fuel is used and working stability of the multi-fuel generator set.

In order to achieve the above-mentioned object of the present disclosure, according to a first aspect of the present disclosure, the present disclosure provides a control system for a multi-fuel generator set, the multi-fuel generator set including a multi-fuel engine and a generator in driving connection to the multi-fuel engine, wherein
the control system includes a fuel switching switch, an engine start switch, a carburetor, a gas supply electric control valve, a signal detection module, an ignition device and a control device, a gas fuel supply pipeline of the multi-fuel engine is connected to a gas inlet of the gas supply electric control valve, a gas outlet of the gas supply electric control valve is connected to a gas fuel inlet of the carburetor, the fuel switching switch and the engine start switch are respectively connected to the signal detection module, and the carburetor, the gas supply electric control valve, the signal detection module and the ignition device are respectively connected to the control device, wherein,
the signal detection module is configured to detect a working state signal of the multi-fuel engine and send the detected working state signal to the control device; and
the control device is configured to control a switching state of the gas supply electric control valve and an ignition timing of the ignition device according to the received working state signal.

Preferably, the signal detection module includes an engine start signal detection circuit, a fuel type detection circuit, a rotation speed sensor and a power detection circuit, signal output ends of the engine start signal detection circuit, the fuel type detection circuit, the rotation speed sensor and the power detection circuit are respectively connected to a signal input end of the control device, a signal input end of the engine start signal detection circuit is connected to the engine start switch, and a signal input end of the fuel type detection circuit is connected to the fuel switching switch, wherein,
the engine start signal detection circuit is configured to detect a state of the engine start switch and output an engine start signal when the engine start switch is in an on state;
the fuel type detection circuit is configured to detect a state of the fuel switching switch and output a corresponding fuel type signal;
the rotation speed sensor is configured to detect a rotation speed signal of the fuel engine; and
the power detection circuit is configured to detect a current signal of a main winding of the generator and convert the current signal into a generated power signal.

Preferably, the signal detection module further includes a temperature sensor, a signal output end of the temperature sensor is connected to the signal input end of the control device, and the temperature sensor is configured to detect a cylinder temperature signal of the fuel engine.

Preferably, the signal detection module further includes an oxygen sensor, a signal output end of the oxygen sensor is connected to the signal input end of the control device, and the oxygen sensor is configured to detect an oxygen content signal in exhaust gas of the fuel engine.

Preferably, the gas supply electric control valve is a high-speed solenoid valve.

Preferably, the ignition device includes an igniter and an ignition coil, a signal input end of the igniter is connected to a signal output end of the control device, and a signal output end of the igniter is connected to a signal input end of the ignition coil.

Preferably, the control device is integrated in an inverter controller of the multi-fuel generator set.

According to a second aspect of the present disclosure, the present disclosure provides a generator set, including any one of the above-mentioned control systems for the multi-fuel generator set.

According to a third aspect of the present disclosure, the present disclosure provides a control method for any one of the above-mentioned control systems for the multi-fuel generator set, wherein the control method includes the following steps:
S1: detecting a working state signal of the multi-fuel engine by the signal detection module and sending the working state signal to the control device, wherein the working state signal at least includes an engine start signal, a fuel type signal, an engine rotation speed signal, and a generated power signal; and
S2: controlling a switching state of the gas supply electric control valve and an ignition timing of the ignition device according to the received working state signal by the control device.

Preferably, in step S2, the controlling a switching state of the gas supply electric control valve and an ignition timing of the ignition device according to the received working state signal by the control device includes:
S21: when the fuel type signal represents that currently selected engine fuel is gas fuel, searching in a preset engine control parameter database for a gas injection pulse width calibration table and an ignition advance angle calibration table corresponding to the fuel type signal according to the fuel type signal, wherein the engine control parameter database stores a plurality of gas injection pulse width calibration tables and ignition advance angle calibration tables of different fuel types, each of the gas injection pulse width calibration tables is configured with gas injection pulse widths corresponding to different engine rotation speeds and generated powers, and each of the ignition advance angle calibration tables is configured with ignition advance angles corresponding to the different engine rotation speeds and generated powers;
S22: searching, based on the engine rotation speed signal and the generated power signal, in the gas injection pulse width calibration table obtained by searching for a gas injection pulse width that matches the engine rotation speed signal and the generated power signal; and searching, based on the engine rotation speed signal and the generated power signal, in the ignition advance angle calibration table obtained by searching for an ignition advance angle that matches the engine rotation speed signal and the generated power signal;
S23: generating a corresponding pulse width modulation (PWM) control signal based on the gas injection pulse width obtained by searching, and generating a corresponding ignition control signal based on the ignition advance angle obtained by searching; and
S24: controlling an on/off state of the gas supply electric control valve based on the PWM control signal, and controlling the ignition timing of the ignition device based on the ignition control signal.

It can be seen from the above solution that the present disclosure provides a control system for a multi-fuel generator set and a control method thereof, and a generator set. On/off connection between the gas fuel supply pipeline and the carburetor is controlled by replacing a pressure reducing valve with the gas supply electric control valve; the signal detection module is set to detect the working state signal of the multi-fuel engine; and the control device is set to control the switching state of the gas supply electric control valve and the ignition time of the ignition device according to the received working state signal, thereby realizing active control of gas fuel supply and ignition of the engine according to the real-time state of the engine, which can effectively improve engine starting performance of the multi-fuel generator set when gas fuel is used and working stability of the multi-fuel generator set.

Additional aspects and advantages of the present disclosure will be set forth in part in the description which follows and, in part, will be obvious from the description which follows, or may be learned by practice of the present disclosure.

### BRIEF DESCRIPTION OF DRAWINGS

The above and/or additional aspects and advantages of the present disclosure will become apparent and readily understood from the following description of the embodiments with reference to the accompanying drawings, in which:

FIG. 1 is a functional block diagram of circuits of a control system for a multi-fuel generator set in a preferred implementation of the present disclosure; and

FIG. 2 is a flow chart of a control method for a control system for a multi-fuel generator set in a preferred implementation of the present disclosure.

### DETAILED DESCRIPTION OF THE EMBODIMENTS

Exemplary embodiments of the present disclosure will be described below in more detail with reference to the accompanying drawings. Although exemplary embodiments of the present disclosure are shown in the drawings, it should be understood that the present disclosure can be embodied in various forms and should not be limited to the embodiments set forth herein. On the contrary, these embodiments are provided to enable a more thorough understanding of the present disclosure and to fully convey the scope of the present disclosure to those skilled in the art.

Those skilled in the art will understand that unless otherwise defined, all terms (including technical and scientific terms) used herein have the same meaning as commonly understood by those ordinarily skilled in the art to which this invention belongs. It should also be understood that terms, such as those defined in commonly used dictionaries, should be understood to have meanings that are consistent with their meanings in the context of the prior art and will not be interpreted in an idealized or overly formal sense unless specifically defined.

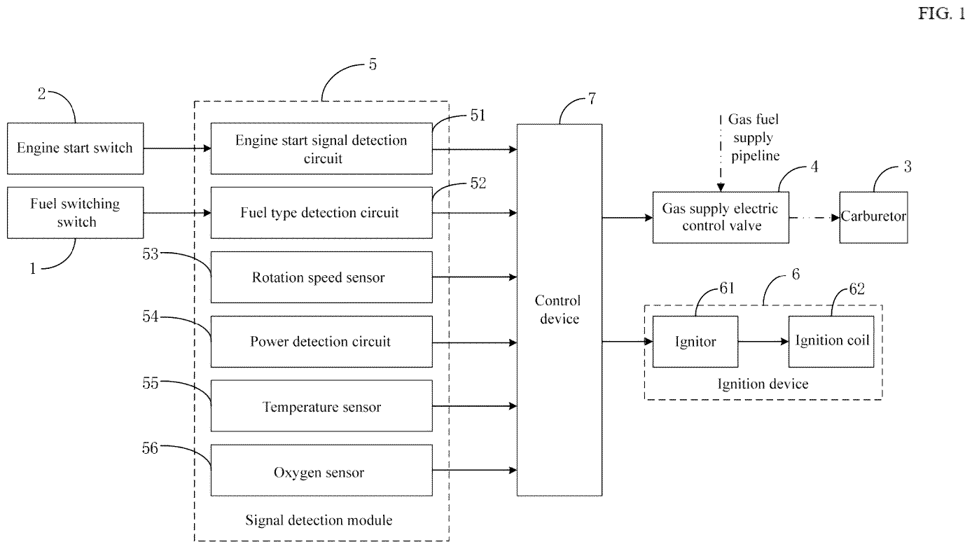

As shown in FIG. 1, an embodiment of the present disclosure provides a control system for a multi-fuel generator set.

Specifically, in this embodiment, the multi-fuel generator set includes a multi-fuel engine and a generator in driving connection to the multi-fuel engine. The control system includes a fuel switching switch 1, an engine start switch 2, a carburetor 3, a gas supply electric control valve 4, a signal detection module 5, an ignition device 6 and a control device 7, a gas fuel supply pipeline of the multi-fuel engine is connected to a gas inlet of the gas supply electric control valve 4, a gas outlet of the gas supply electric control valve 4 is connected to a gas fuel inlet of the carburetor 3, the fuel switching switch 1 and the engine start switch 2 are respectively connected to the signal detection module 5, and the carburetor 3, the gas supply electric control valve 4, the signal detection module 5 and the ignition device 6 are respectively connected to the control device 7, wherein,
the signal detection module 5 is configured to detect a working state signal of the multi-fuel engine and send the detected working state signal to the control device 7; and
the control device 7 is configured to control a switching state of the gas supply electric control valve 4 and an ignition timing of the ignition device 6 according to the received working state signal.

The working principle of the control system for the multi-fuel generator set in this embodiment is as follows.

When the multi-fuel generator set is started or operating normally, the signal detection module 5 is configured to detect state signals of the fuel switching switch 1 and the engine start switch 2, thereby realizing detection of engine working state signals such as a fuel type signal and an engine start signal of the multi-fuel engine, and sending the detected working state signal to the control device 7. The control device 7 controls the switching state of the gas supply electric control valve 4 and the ignition time of the ignition device 6 according to the received working state signal, thereby realizing active control of engine gas supply and precise control of the engine ignition time.

The control system for the multi-fuel generator set of this embodiment can actively control the supply of gas fuel and accurately control the ignition timing of the engine according to the real-time state of the engine. When the engine is started, a gas intake of the gas fuel is no longer determined by an engine negative pressure, which effectively avoids the problem of inconsistent gas fuel intakes at a same rotation speed, can effectively improve engine starting performance of the multi-fuel generator set when gas fuel is used and the working stability of the multi-fuel generator set, and achieve effects of energy saving and emission reduction.

In one embodiment, the signal detection module 5 includes an engine start signal detection circuit 51, a fuel type detection circuit 52, a rotation speed sensor 53 and a power detection circuit 54, signal output ends of the engine start signal detection circuit 51, the fuel type detection circuit 52, the rotation speed sensor 53 and the power detection circuit 54 are respectively connected to a signal input end of the control device 7, a signal input end of the engine start signal detection circuit 51 is connected to the engine start switch 2, and a signal input end of the fuel type detection circuit 52 is connected to the fuel switching switch 1, wherein,
the engine start signal detection circuit 51 is configured to detect a state of the engine start switch 2 and output an engine start signal when the engine start switch 2 is in an on state;
the fuel type detection circuit 52 is configured to detect a state of the fuel switching switch 1 and output a corresponding fuel type signal;
the rotation speed sensor 53 is configured to detect a rotation speed signal of the fuel engine; and
the power detection circuit 54 is configured to detect a current signal of a main winding of the generator and convert the current signal into a generated power signal.

An existing control method for a multi-fuel generator set only detects an engine rotation speed and controls the ignition timing of the ignition device 6 according to the engine rotation speed. In this embodiment, the signal detection module 5 respectively detects an engine start signal, a fuel type signal, a rotation speed signal and a generated power signal by setting the engine start signal detection circuit 51, the fuel type detection circuit 52, the rotation speed sensor 53 and the power detection circuit 54, so that the control device 7 can output a corresponding solenoid valve control signal and a corresponding ignition control signal according to the engine start signal, fuel type signal, rotation speed signal and generated power signal to respectively control the switching state of the gas supply electric control valve 4 and the ignition timing of the ignition device 6. On the basis of detecting the engine rotation speed, a load is identified by detecting the generated power, thereby realizing ignition angle control at different speeds and different loads, so that the engine can operate in the best working conditions at each load point, effectively improving the working efficiency of the multi-fuel generator and achieving energy saving and emission reduction.

In one embodiment, the signal detection module 5 further includes a temperature sensor 55, a signal output end of the temperature sensor 55 is connected to the signal input end of the control device 7, and the temperature sensor 55 is configured to detect a cylinder temperature signal of the fuel engine.

In this embodiment, the signal detection module 5 detects the cylinder temperature signal of the engine by setting a temperature sensor 55, so that the control device 7 can further adjust a gas fuel injection amount and a throttle percentage according to a cylinder temperature of the engine, thereby improving starting performance of the engine when the engine is cold.

In one embodiment, the signal detection module 5 further includes an oxygen sensor 56, a signal output end of the oxygen sensor 56 is connected to the signal input end of the control device 7, and the oxygen sensor 56 is configured to detect an oxygen content signal in exhaust gas of the fuel engine.

In this embodiment, the signal detection module 5 detects an oxygen content in the exhaust gas of the engine by setting an oxygen sensor 56. The control device 7 can calculate a carbon monoxide content in the exhaust gas based on this, so as to judge a combustion condition of the fuel in the engine. The control device 7 can control the throttle percentage according to the detected oxygen content signal in the exhaust gas of the fuel engine to adjust an air-fuel ratio, thereby improving the working efficiency of the engine, and further achieving energy saving and emission reduction.

In one embodiment, the gas supply electric control valve 4 is a high-speed solenoid valve.

The response time of the high-speed solenoid valve is very fast and can complete valve opening and closing operations within milliseconds. This fast response characteristic enables the high-speed solenoid valve to achieve high-frequency switching and precise flow control. The control device 7 can control switching time of the high-speed solenoid valve through a pulse width modulation (PWM) signal, thereby more accurately realizing control of the gas fuel injection time and amount, and improving the combustion efficiency and power output of the engine.

In one embodiment, the ignition device 6 includes an igniter 61 and an ignition coil 62, a signal input end of the igniter 61 is connected to a signal output end of the control device 7, and a signal output end of the igniter 61 is connected to a signal input end of the ignition coil 62.

In this embodiment, the igniter 61 is responsible for controlling a working state of the ignition coil 62. The igniter determines when to generate high voltage electricity by controlling on/off of the current, thereby controlling the ignition timing of a spark plug. The main function of the ignition coil 62 is to convert a low voltage provided by a power supply into a high voltage. This high voltage electricity will be guided to the spark plug to generate sparks to ignite an air-fuel mixture of the engine.

In one embodiment, the control device 7 is integrated in an inverter controller of the multi-fuel generator set.

In the multi-fuel generator set, the inverter controller serves as a main control component of the generator set and controls working states of the engine and the generator. In this embodiment, by integrating the control device 7 in the inverter controller of the multi-fuel generator set, centralized control is achieved while effectively reducing wiring of the control system.

In some other embodiments, the control device 7 may also be an engine (electronic control unit) ECU or an independent control device.

An embodiment of the present disclosure further provides a generator set, which includes the control system for the multi-fuel generator set in any of the above embodiments.

The working principle of the generator set in this embodiment is the same as the working principle of the control system for the multi-fuel generator set in the above embodiment, and will not be repeated here. Since the generator set in this embodiment adopts the control system for the multi-fuel generator set in the above embodiment, the generator set has the same beneficial effects as the control system for the multi-fuel generator set, and can also actively control supply of gas fuel and ignition of the engine according to the real-time state of the engine, thereby effectively improving engine starting performance of the multi-fuel generator set when gas fuel is used and working stability of the multi-fuel generator set.

Specifically, the generator set in this embodiment is a gas-liquid mixed three-fuel generator set using LPG, NG and gasoline as fuel.

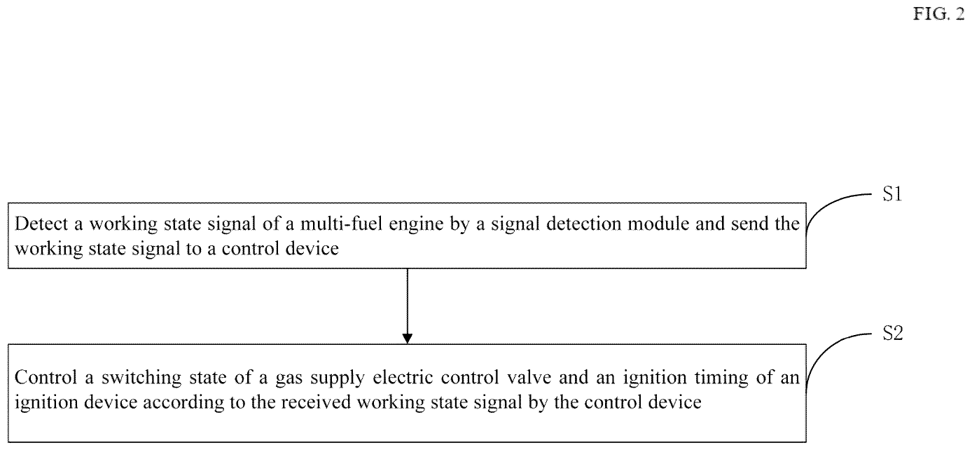

As shown in FIG. 2, an embodiment of the present disclosure further provides a control method for any of the above-mentioned control systems for the multi-fuel generator set. The control method may include the following steps:
S1: detecting a working state signal of the multi-fuel engine by the signal detection module and sending the working state signal to the control device, wherein the working state signal at least includes an engine start signal, a fuel type signal, an engine rotation speed signal, and a generated power signal; and
S2: controlling a switching state of the gas supply electric control valve and an ignition timing of the ignition device according to the received working state signal by the control device.

The control method for the control system for the multi-fuel generator set of this embodiment is adopted. When the multi-fuel generator set is started or operates normally, state signals of the fuel switching switch and the engine start switch, that is, the fuel type signal and the engine start signal, are detected by the signal detection module, and engine working state signals such as the engine rotation speed signal and the generated power signal are detected, and the detected working state signals are sent to the control device. The control device controls the switching state of the gas supply electric control valve and the ignition timing of the ignition device according to the received working state signals, thereby realizing active control of engine gas supply and precise control of the engine ignition timing.

The control method for the control system for the multi-fuel generator set of this embodiment can actively control the supply of gas fuel and accurately control the ignition timing of the engine according to the real-time state of the engine. When the engine is started, the gas intake of gas fuel is no longer determined by the engine negative pressure, which effectively avoids the problem of inconsistent gas fuel intakes at a same rotation speed, can effectively improve engine starting performance of the multi-fuel generator set when gas fuel is used and working stability of the multi-fuel generator set, and achieve effects of energy saving and emission reduction.

In one embodiment, in step S2, the controlling a switching state of the gas supply electric control valve and an ignition timing of the ignition device according to the received working state signal by the control device includes:
S21: when the fuel type signal represents that currently selected engine fuel is gas fuel, searching in a preset engine control parameter database for a gas injection pulse width calibration table and an ignition advance angle calibration table corresponding to the fuel type signal according to the fuel type signal, wherein the engine control parameter database stores a plurality of gas injection pulse width calibration tables and ignition advance angle calibration tables of different fuel types, each of the gas injection pulse width calibration tables is configured with gas injection pulse widths corresponding to different engine rotation speeds and generated powers, and each of the ignition advance angle calibration tables is configured with ignition advance angles corresponding to the different engine rotation speeds and generated powers.

Specifically, the gas injection pulse width calibration table and the ignition advance angle calibration table may be calibrated according to experiments before the generator set leaves the factory and stored in the engine control parameter database in the engine control unit.

Specifically, in the engine control parameter database, for the gas fuel used by the generator set, each gas fuel has a gas injection pulse width calibration table and an ignition advance angle calibration table stored, wherein:
as shown in Table 1, which is a gas injection pulse width calibration table of NG, the data in the first row of the table represents the engine rotation speed (in r/min), the data in the first column represents the generated power of the generator set (in W), and the data in the remaining grids represents the gas injection pulse width (in ms) corresponding to each rotation speed and power (i.e., the pulse width of a PWM signal output by the control device to control the gas supply electronic control valve);
as shown in Table 2, which is an ignition advance angle calibration table of NG, the data in the first row of the ignition advance angle calibration table represents the engine rotation speed, the data in the first column represents the generated power of the generator set, and the data in the remaining grids represents the ignition advance angle (in °) of the ignition device corresponding to each rotation speed and power.

For example, when the fuel type signal represents that currently selected engine fuel is NG, the gas injection pulse width calibration table and ignition advance angle calibration table corresponding to the fuel type signal are searched in the preset engine control parameter database according to the fuel type signal, which are Table 1 and Table 2 respectively.

TABLE 1
Gas Injection Pulse Width Calibration Table of NG

| | Rotation speed | | | | | | |
|---|---|---|---|---|---|---|---|
| Power | 2000 | 2500 | 3000 | 3400 | 3600 | 3800 | 4000 |
| 4500 | 20.125 | 23.453 | 23.453 | 28.855 | 28.855 | 28.855 | 28.855 |
| 4000 | 20.125 | 22.986 | 23.453 | 27.991 | 27.991 | 27.991 | 27.991 |
| 3500 | 13.345 | 15.850 | 16.172 | 20.093 | 21.690 | 26.990 | 26.990 |
| 3000 | 9.901 | 7.036 | 7.179 | 20.880 | 19.264 | 25.183 | 25.183 |
| 2500 | 9.432 | 6.322 | 6.450 | 19.389 | 18.438 | 23.865 | 23.865 |
| 2000 | 9.112 | 6.320 | 6.448 | 15.953 | 18.156 | 18.893 | 18.893 |
| 1500 | 8.112 | 5.733 | 5.849 | 13.822 | 17.202 | 17.548 | 17.548 |
| 1000 | 8.125 | 6.452 | 6.583 | 12.304 | 16.094 | 15.461 | 15.461 |
| 500 | 6.222 | 5.043 | 5.145 | 10.176 | 11.018 | 10.584 | 10.584 |

TABLE 2
Ignition Advance Angle Calibration Table of NG

| | Rotation speed | | | | | | |
|---|---|---|---|---|---|---|---|
| Power | 1000 | 2000 | 3000 | 3400 | 3600 | 3800 | 4000 |
| 4500 | 15.000 | 22.000 | 22.000 | 22.000 | 22.000 | 22.000 | 22.000 |
| 4000 | 15.000 | 22.000 | 22.000 | 22.000 | 22.000 | 22.000 | 22.000 |
| 3500 | 15.000 | 22.000 | 22.000 | 22.000 | 22.000 | 22.000 | 22.000 |
| 3000 | 15.000 | 22.000 | 22.000 | 22.000 | 22.000 | 22.000 | 22.000 |
| 2500 | 15.000 | 22.000 | 22.000 | 22.000 | 22.000 | 22.000 | 22.000 |
| 2000 | 15.000 | 22.000 | 22.000 | 22.000 | 22.000 | 22.000 | 22.000 |
| 1500 | 15.000 | 22.000 | 22.000 | 22.000 | 22.000 | 22.000 | 22.000 |
| 1000 | 15.000 | 22.000 | 22.000 | 22.000 | 22.000 | 22.000 | 22.000 |
| 500 | 15.000 | 22.000 | 22.000 | 22.000 | 22.000 | 22.000 | 22.000 |

S22: searching, based on the engine rotation speed signal and the generated power signal, in the gas injection pulse width calibration table obtained by searching for a gas injection pulse width that matches the engine rotation speed signal and the generated power signal; and searching, based on the engine rotation speed signal and the generated power signal, in the ignition advance angle calibration table obtained by searching for an ignition advance angle that matches the engine rotation speed signal and the generated power signal;

for example, in Table 1, when the engine rotation speed is 2000 r/min and the generated power is 4500 W, the corresponding gas injection pulse width is 20.125 ms; in Table 2, when the engine rotation speed is 2000 r/min and the generated power is 4500 W, the corresponding ignition advance angle is 15.00°.
S23: generating a corresponding pulse width modulation (PWM) control signal based on the gas injection pulse width obtained by searching, and generating a corresponding ignition control signal based on the ignition advance angle obtained by searching;

a duty cycle of the PWM signal can be calculated through the gas injection pulse width, and the ignition timing of the ignition device can be calculated through the ignition advance angle. Therefore, after finding the gas injection pulse width and ignition advance angle corresponding to the current fuel, current rotation speed and current generated power, the corresponding PWM control signal can be generated according to the gas injection pulse width obtained by searching, and the corresponding ignition control signal can be generated based on the ignition advance angle obtained by searching.
S24: controlling an on/off state of the gas supply electric control valve based on the PWM control signal, and controlling the ignition timing of the ignition device based on the ignition control signal.

Finally, the switching state of the gas supply electronic control valve can be controlled according to the generated PWM control signal, thereby controlling the gas intake of gas fuel, and the ignition timing of the ignition device can be controlled according to the generated ignition control signal, thereby accurately controlling the ignition timing. The combination of both can effectively ensure that the engine operates in the best working conditions.

In this embodiment, optimal operating parameters of the engine are matched by the above-mentioned table searching method, which makes the internal operation process of the program simpler when the engine is started and during the operation of the engine. The matching efficiency and matching accuracy between the current working state parameters of the engine and control parameters of the engine are higher.

In addition, a corresponding gas injection pulse width calibration table and a corresponding ignition advance angle calibration table are set for each gas fuel. In this way, the engine control parameters between various gas fuels have obvious independence. In the subsequent use process or for different engine products, when the engine control parameters of different fuels need to be added, the cost increment involved in separately adding the gas injection pulse width calibration table and the ignition advance angle calibration table is relatively small. In addition, when the control program during engine startup and operation is upgraded by modifying the control parameters in the corresponding gas injection pulse width calibration table and the ignition advance angle calibration table, each gas injection pulse width calibration table and each ignition advance angle calibration table can be optimized separately without affecting the normal use of other gas injection pulse width calibration tables and ignition advance angle calibration tables.

It should be noted that due to limited length, the gas injection pulse width calibration table shown in Table 1 and the ignition advance angle calibration table shown in Table 2 only display part of the gas injection pulse width and ignition advance angle data corresponding to the engine rotation speed and generated power. In actual application, data points of the engine rotation speed and generated power may be denser. For example, a data point may be set for every 100 r/min of engine rotation speed, and a data point may be set for every 100 W of generated power. When the actual data of the detected engine rotation speed and generated power deviate from the data points in the table, the data corresponding to the data point closest to the calibrated data point in the table is used. For example, when the detected engine rotation speed is 2465 r/min and the detected generated power is 2123 W, the gas injection pulse width corresponding to the engine rotation speed of 2500 r/min and the generated power of 2100 W is selected from the gas injection pulse width calibration table.

It can be understood that the denser the data points in Table 1 and Table 2, the more accurate the gas injection pulse width and ignition advance angle data obtained by searching the tables.

In one embodiment, to optimize the operating efficiency of the generator set at different temperatures, the optimal supply amount of gas fuel required for engine startup and normal operation at the same power and speed is also different. When the power and rotation speed are constant, the engine efficiency is low when running cold. In order to maintain the optimal operating efficiency of the multi-fuel engine at different temperatures, based on the previous embodiment, the injection amount of gas fuel can be further compensated according to an engine cylinder temperature. Therefore, a control method provided in this embodiment may include the following steps:
S1′: detecting a working state signal of the multi-fuel engine by the signal detection module and sending the working state signal to the control device, wherein the working state signal at least includes an engine start signal, a fuel type signal, an engine rotation speed signal, a generated power signal, and a cylinder temperature signal;
S2′: controlling a switching state of the gas supply electric control valve and an ignition timing of the ignition device according to the received working state signal by the control device. The specific process is as follows:
S21′: when the fuel type signal represents that currently selected engine fuel is gas fuel, searching in a preset engine control parameter database for a gas injection pulse width calibration table, an ignition advance angle calibration table and a gas injection compensation amount calibration table corresponding to the fuel type signal according to the fuel type signal, wherein the engine control parameter database stores a plurality of gas injection pulse width calibration tables, ignition advance angle calibration tables and gas injection compensation amount calibration tables of different fuel types, each of the gas injection pulse width calibration tables is configured with gas injection pulse widths corresponding to different engine rotation speeds and generated powers, each of the ignition advance angle calibration tables is configured with ignition advance angles corresponding to the different engine rotation speeds and generated powers, and each of the gas injection compensation amount calibration tables is configured with gas injection pulse width compensation coefficients corresponding to the different generated powers and cylinder temperatures;
S22′: searching, based on the engine rotation speed signal and the generated power signal, in the gas injection pulse width calibration table obtained by searching for a gas injection pulse width that matches the engine rotation speed signal and the generated power signal; and searching, based on the engine rotation speed signal and the generated power signal, in the ignition advance angle calibration table obtained by searching for an ignition advance angle that matches the engine rotation speed signal and the generated power signal;

for example, in Table 1, when the engine rotation speed is 2000 r/min and the generated power is 4500 W, the corresponding gas injection pulse width is 20.125 ms; in Table 2, when the engine rotation speed is 2000 r/min and the generated power is 4500 W, the corresponding ignition advance angle is 15.00°.
S23′: searching, based on the generated power signal and the cylinder temperature signal, in the gas injection compensation amount calibration table obtained by searching for a gas injection pulse width compensation coefficient that matches the generated power signal and the cylinder temperature signal;

as shown in Table 3, which is a gas injection compensation amount calibration table of NG, the data in the first row of the table represents the engine cylinder temperature (in ° C.), the data in the first column represents the generated power of the generator set, and the data in the remaining grids represent the gas injection pulse width compensation coefficient corresponding to each temperature and power. For example, in Table 3, when the engine cylinder temperature is −20° C. and the generated power is 4500 W, the corresponding gas injection pulse width compensation coefficient is 11.00.

When the fuel type signal represents that currently selected engine fuel is NG, the gas injection pulse width calibration table, ignition advance angle calibration table, and gas injection compensation amount calibration table corresponding to the fuel type signal are searched in the preset engine control parameter database according to the fuel type signal, which are Table 1, Table 2, and Table 3 respectively.

TABLE 3
Gas Injection Compensation Amount Calibration Table of NG

| | Temperature | | | | | | |
|---|---|---|---|---|---|---|---|
| Power | −20.0 | −10.0 | 0.0 | 10.0 | 30.0 | 60.0 | 100.0 |
| 4500 | 11.000 | 10.800 | 10.300 | 10.000 | 10.000 | 10.000 | 10.000 |
| 4000 | 11.000 | 10.800 | 10.300 | 10.000 | 10.000 | 10.000 | 10.000 |
| 3500 | 11.000 | 10.800 | 10.300 | 10.000 | 10.000 | 10.000 | 10.000 |
| 3000 | 11.000 | 10.800 | 10.300 | 10.000 | 10.000 | 10.000 | 10.000 |
| 2500 | 11.000 | 10.800 | 10.300 | 10.000 | 10.000 | 10.000 | 10.000 |
| 2000 | 11.000 | 10.800 | 10.300 | 10.000 | 10.000 | 10.000 | 10.000 |
| 1500 | 11.000 | 10.800 | 10.300 | 10.000 | 10.000 | 10.000 | 10.000 |
| 1000 | 12.000 | 11.000 | 10.800 | 10.000 | 10.000 | 10.000 | 10.000 |
| 500 | 12.000 | 11.000 | 10.800 | 10.000 | 10.000 | 10.000 | 10.000 |

S24′: based on the gas injection pulse width that matches the engine rotation speed signal and the generated power signal obtained by searching the table, and the gas injection pulse width compensation coefficient that matches the generated power signal and the cylinder temperature signal obtained by searching the table, obtaining a gas injection pulse width after temperature compensation; that is, the gas injection pulse width that matches the engine rotation speed signal and the generated power signal obtained by searching the table, and the gas injection pulse width compensation coefficient that matches the generated power signal and the cylinder temperature signal obtained by searching the table are calculated according to preset rules (in this embodiment, the result is the product of the gas injection pulse width and the gas injection pulse width compensation coefficient, which is divided by 10) to obtain the gas injection pulse width after temperature compensation.
S25′: generating a corresponding PWM control signal based on the gas injection pulse width after temperature compensation obtained by calculation, and generating a corresponding ignition control signal based on the ignition advance angle obtained by searching;

a duty cycle of the PWM signal can be calculated through the gas injection pulse width after temperature compensation, and the ignition timing of the ignition device can be calculated through the ignition advance angle.
S26′: controlling an on/off state of the gas supply electric control valve based on the generated PWM control signal, and controlling the ignition timing of the ignition device based on the generated ignition control signal.

Since different temperatures and different fuel types require different amounts of air to optimize the combustion efficiency of gas fuel, in order to optimize the combustion efficiency of the multi-fuel engine at different temperatures, in one embodiment, a control method of the present disclosure may further include the following steps:
detecting a cylinder temperature signal of the multi-fuel engine by the signal detection module and sending the signal to the control device;
controlling a throttle percentage of the carburetor according to the received cylinder temperature signal and fuel type signal by the control device. The specific process is as follows:

searching in a throttle percentage calibration table in a preset engine control parameter database, for throttle percentage information that matches the received cylinder temperature signal and fuel type signal according to the received cylinder temperature signal and fuel type signal;
generating a corresponding throttle control signal based on the throttle percentage information obtained by searching; and
controlling the throttle percentage of the carburetor based on the generated throttle control signal.

Specifically, a throttle percentage calibration table is shown in Table 4:

TABLE 4
Throttle Percentage Calibration Table

| | Temperature | | | | | | |
|---|---|---|---|---|---|---|---|
| Fuel type | −20.0 | −10.0 | 0.0 | 10.0 | 30.0 | 60.0 | 100.0 |
| LPG | 911 | 911 | 1012 | 1012 | 1012 | 1012 | 1012 |
| NG | 800 | 800 | 800 | 800 | 800 | 800 | 800 |

The data in the first row of the throttle percentage calibration table represents the engine cylinder temperature (in ° C.), the data in the first column represents the fuel type, and the data in the remaining grids represents the throttle percentage data of the carburetor corresponding to each temperature and fuel type. It should be noted that the throttle percentage data in the table is not the actual throttle percentage, but a throttle percentage coefficient that is positively correlated with the throttle percentage.

In order to improve the success rate of one-time startup of the engine, the gas supply electronic control valve may be opened in advance when the engine is started to pre-inject some gas fuel into the engine cylinder, thereby enriching the gas fuel in the engine cylinder. Since different temperatures and different fuel types require different amounts of gas fuel to optimize the one-time startup success rate of the engine, in order to optimize the one-time startup success rate of the engine at different temperatures, in one embodiment, a control method of the present disclosure may further include the following steps:
detecting the cylinder temperature signal of the multi-fuel engine by the signal detection module and sending the signal to the control device; and
controlling pre-injection opening time of the gas supply electronic control valve according to the received cylinder temperature signal and fuel type signal by the control device. The specific process is as follows:

searching, according to the received cylinder temperature signal and fuel type signal, in a pre-injection time calibration table in a preset engine control parameter database for pre-injection time information that matches the received cylinder temperature signal and fuel type signal;
generating a corresponding pre-injection control signal based on the pre-injection time information obtained by searching; and
controlling pre-injection opening time of the gas supply electric control valve based on the generated pre-injection control signal.

Specifically, a pre-injection time calibration table is shown in Table 5:

TABLE 5
Pre-injection Time Calibration Table

| | Temperature | | | | | | |
|---|---|---|---|---|---|---|---|
| Fuel type | −20.0 | −10.0 | 0.0 | 10.0 | 30.0 | 60.0 | 100.0 |
| LPG | 30 | 30 | 30 | 30 | 20 | 20 | 15 |
| NG | 125 | 100 | 80 | 75 | 40 | 20 | 10 |

The data in the first row of the pre-injection time calibration table represents the engine cylinder temperature (in ° C.), the data in the first column represents the fuel type, and the data in the remaining grids represents the pre-injection opening time (in ms) of the gas supply electronic control valve corresponding to each temperature and fuel type.

The present disclosure implements all or part of the processes in the control method for the control system for the multi-fuel generator set in the above-mentioned embodiment, which can be completed by instructing relevant hardware through a computer program. The computer program may be stored in a computer-readable storage medium. When the computer program is executed by the processor, the computer program can implement the steps of the above-mentioned various method embodiments. The computer program includes computer program code, which may be in source code form, object code form, executable file, or some intermediate form. The computer-readable medium may include: any entity or device, recording medium, USB flash drive, mobile hard disk, magnetic disk, optical disk, computer memory, read-only memory (ROM), random access memory (RAM), electrical carrier signal, telecommunication signal, and software distribution medium capable of carrying the computer program code. It should be noted that the content contained in the computer-readable medium can be appropriately increased or decreased according to the requirements of legislation and patent practices in the jurisdiction. For example, in some jurisdictions, according to legislation and patent practices, computer-readable media do not include electrical carrier signals and telecommunication signals.

Those skilled in the art will appreciate that although some embodiments herein include certain features included in other embodiments, but not other features, the combination of features from different embodiments is intended to be within the scope of the present disclosure and to form different embodiments. For example, in the following claims, any of the claimed embodiments can be used in any combination.

Finally, it should be noted that: the above embodiments are only configured to illustrate the technical solutions of the present disclosure, rather than to limit them. Although the present disclosure has been described in detail with reference to the foregoing embodiments, it will be understood by those of ordinary skill in the art that: it is still possible to modify the technical solutions described in the aforementioned embodiments, or to replace some of the technical features therein with equivalents; however, these modifications or replacements do not deviate the essence of the corresponding technical solutions from the spirit and scope of the technical solutions of the embodiments of the present disclosure.

What is claimed is:

1. A control system for a multi-fuel generator set, the multi-fuel generator set comprising a multi-fuel engine and a generator in driving connection to the multi-fuel engine, wherein:
the control system comprises a fuel switching switch, an engine start switch, a carburetor, a gas supply electric control valve, a signal detection module, an ignition device and a control device, a gas fuel supply pipeline of the multi-fuel engine is connected to a gas inlet of the gas supply electric control valve, a gas outlet of the gas supply electric control valve is connected to a gas fuel inlet of the carburetor, the fuel switching switch and the engine start switch are respectively connected to the signal detection module, and the carburetor, the gas supply electric control valve, the signal detection module and the ignition device are respectively connected to the control device, wherein,
the signal detection module is configured to detect a working state signal of the multi-fuel engine and send the detected working state signal to the control device; and
the control device is configured to control a switching state of the gas supply electric control valve and an ignition timing of the ignition device according to the received working state signal.

2. The control system for the multi-fuel generator set according to claim 1, wherein the signal detection module comprises an engine start signal detection circuit, a fuel type detection circuit, a rotation speed sensor and a power detection circuit, signal output ends of the engine start signal detection circuit, the fuel type detection circuit, the rotation speed sensor and the power detection circuit are respectively connected to a signal input end of the control device, a signal input end of the engine start signal detection circuit is connected to the engine start switch, and a signal input end of the fuel type detection circuit is connected to the fuel switching switch, wherein,
the engine start signal detection circuit is configured to detect a state of the engine start switch and output an engine start signal when the engine start switch is in an on state;
the fuel type detection circuit is configured to detect a state of the fuel switching switch and output a corresponding fuel type signal;
the rotation speed sensor is configured to detect a rotation speed signal of the fuel engine; and
the power detection circuit is configured to detect a current signal of a main winding of the generator and convert the current signal into a generated power signal.

3. The control system for the multi-fuel generator set according to claim 2, wherein the signal detection module further comprises a temperature sensor, a signal output end of the temperature sensor is connected to the signal input end of the control device, and the temperature sensor is configured to detect a cylinder temperature signal of the fuel engine.

4. The control system for the multi-fuel generator set according to claim 2, wherein the signal detection module further comprises an oxygen sensor, a signal output end of the oxygen sensor is connected to the signal input end of the control device, and the oxygen sensor is configured to detect an oxygen content signal in exhaust gas of the fuel engine.

5. The control system for the multi-fuel generator set according to claim 1, wherein the gas supply electric control valve is a high-speed solenoid valve.

6. The control system for the multi-fuel generator set according to claim 1, wherein the ignition device comprises an igniter and an ignition coil, a signal input end of the igniter is connected to a signal output end of the control device, and a signal output end of the igniter is connected to a signal input end of the ignition coil.

7. The control system for the multi-fuel generator set according to claim 1, wherein the control device is integrated in an inverter controller of the multi-fuel generator set.

8. A generator set, wherein the generator set comprises the control system for the multi-fuel generator set according to claim 1.

9. A control method for the control system for the multi-fuel generator set according to claim 1, wherein the control method comprises the following steps:
S1: detecting a working state signal of the multi-fuel engine by the signal detection module and sending the working state signal to the control device, wherein the working state signal at least comprises an engine start signal, a fuel type signal, an engine rotation speed signal, and a generated power signal; and
S2: controlling a switching state of the gas supply electric control valve and an ignition timing of the ignition device according to the received working state signal by the control device.

10. The control method for the control system for the fuel generator set according to claim 9, wherein in step S2, the controlling a switching state of the gas supply electric control valve and an ignition timing of the ignition device according to the received working state signal by the control device comprises:
S21: when the fuel type signal represents that currently selected engine fuel is gas fuel, searching in a preset engine control parameter database for a gas injection pulse width calibration table and an ignition advance angle calibration table corresponding to the fuel type signal according to the fuel type signal, wherein the engine control parameter database stores a plurality of gas injection pulse width calibration tables and ignition advance angle calibration tables of different fuel types, each of the gas injection pulse width calibration tables is configured with gas injection pulse widths corresponding to different engine rotation speeds and generated powers, and each of the ignition advance angle calibration tables is configured with ignition advance angles corresponding to the different engine rotation speeds and generated powers;
S22: searching, based on the engine rotation speed signal and the generated power signal, in the gas injection pulse width calibration table obtained by searching for a gas injection pulse width that matches the engine rotation speed signal and the generated power signal; and searching, based on the engine rotation speed signal and the generated power signal, in the ignition advance angle calibration table obtained by searching for an ignition advance angle that matches the engine rotation speed signal and the generated power signal;
S23: generating a corresponding pulse width modulation (PWM) control signal based on the gas injection pulse width obtained by searching, and generating a corresponding ignition control signal based on the ignition advance angle obtained by searching; and
S24: controlling an on/off state of the gas supply electric control valve based on the PWM control signal, and controlling the ignition timing of the ignition device based on the ignition control signal.
